(19) United States
(12) Patent Application Publication
(10) Pub. No.: US 2017/0152816 A1
(43) Pub. Date: Jun. 1, 2017

(54) FIN - SHAPED - PLATE (FSP) EGR COOLER

(71) Applicant: Hanon Systems, Daejeon (KR)

(72) Inventors: Carsten Ohrem, Bergheim (DE); Michael Gauss, Koln (DE); Jürgen Nothbaum, Aachen (DE)

(21) Appl. No.: 15/361,592

(22) Filed: Nov. 28, 2016

(30) Foreign Application Priority Data
Nov. 27, 2015 (DE) 102015120591.2
Nov. 22, 2016 (DE) 102016122455.3

(51) Int. Cl. F02M 26/32

(52) U.S. Cl. CPC F02M 26/32

(57) ABSTRACT

A heat exchanger includes a heat exchanger housing with an exhaust gas inlet adapter and an exhaust gas outlet adapter, which encloses and bounds off a flow space for a coolant. The heat exchanger is furthermore configured with platelike heat exchanger elements arranged in parallel with each other and forming exhaust gas flow ducts, through which exhaust gas flows and around which liquid coolant flows. A heat exchanger element comprises two wall elements, which are joined together on opposite side surfaces and are configured with ribs on both surfaces. The ribs are arranged on an inner side and within the exhaust gas flow duct and on an outer side of the heat exchanger element. Adjacent heat exchanger elements arranged with outer sides facing each other are joined together at end faces abutting each other, forming a coolant flow duct having the ribs disposed therein.

### CROSS-REFERENCE TO RELATED APPLICATIONS

This patent application claims priority under 35 U.S.C. §119 to German Patent Application No. 10 2015 120 591.2 filed on Nov. 27, 2015, and German Patent Application No. 10 2016 122 455.3 filed on Nov. 22, 2016, the disclosures of which are incorporated herein by reference in their entirety.

### TECHNICAL FIELD

The invention concerns a heat exchanger for exhaust gas cooling in motor vehicles. The heat exchanger comprises a heat exchanger housing with an exhaust gas inlet adapter and an exhaust gas outlet adapter, which encloses and bounds off a flow space for a coolant and which comprises an inlet opening as well as an outlet opening for the coolant. The heat exchanger is furthermore configured with platelike heat exchanger elements arranged in parallel with each other and forming exhaust gas flow ducts, through which exhaust gas flows and around which liquid coolant flows.

Furthermore, the invention concerns a method for the production of a heat exchanger element of the heat exchanger.

### BACKGROUND

Systems for exhaust gas recirculation in motor vehicles are known from the prior art, with which the nitrogen oxides in the exhaust gases of motor vehicles, especially in the exhaust gases of diesel-operated motor vehicles, are reduced and the fuel consumption of gasoline-operated motor vehicles is decreased. In the exhaust gas recirculation systems of this kind, cooled or noncooled exhaust gas is mixed in with the fresh air taken in by the engine.

During combustion at high temperatures, environmentally harmful nitrogen oxides are produced in the engine of motor vehicles, especially when using lean fuel mixtures, that is, in the partial load range. In order to decrease the emission of nitrogen oxides, a lowering of the high temperature peaks and a decreasing of the excess air during combustion is necessary. Thanks to the lower oxygen concentration of the fuel and air mixture, a rate of the combustion process and thus the maximum combustion temperatures are reduced. Both effects are accomplished by mixing in a partial flow of exhaust gas in the fresh air flow taken in by the engine.

In diesel-operated motor vehicles, an exhaust gas recirculation system accomplishes a decrease in noise emissions in addition to the lowering of the oxygen fraction and the temperature peaks during the combustion. In gasoline-operated motor vehicles with an exhaust gas recirculation system, the throttling losses are furthermore decreased.

However, the mixing in of the recirculated exhaust gas flow with high temperatures reduces the cooling effect of the exhaust gas recirculation on the combustion. Furthermore, a mixture of air and exhaust with high temperatures that is aspirated by the engine has negative impact on the cylinder filling and thus on the power density of the engine. In order to counteract the negative effects, prior to the mixing the exhaust gas is cooled down in a heat exchanger, the so-called exhaust gas heat exchanger or exhaust gas recirculation cooler.

Various designs of exhaust gas heat exchangers are known from the prior art. However, increasingly strict legislation regarding exhaust gas standards and fuel consumption requirements for motor vehicles are making necessary an increased need for cooling with ever smaller footprint of the components in the motor vehicle. These contrary requirements are seldom fulfilled by the known exhaust gas heat exchangers.

FIGS. 1A and 1B show a heat exchanger 1′ of the prior art, designed as a ribbed heat exchanger, in an exploded view. The heat exchanger 1′, through which exhaust gas flows on the one hand and coolant on the other hand, comprises a heat exchanger housing 2 with a first heat exchanger housing element 2a and a second heat exchanger housing element 2b, which in the enclosed state fully bound off the volume surrounded by the heat exchanger housing 2. At the end faces of the heat exchanger housing 2 there are formed an exhaust gas inlet 3a and an exhaust gas outlet 3b. In the regions of the exhaust gas inlet 3a and exhaust gas outlet 3b formed distally to each other in a lengthwise direction L the volume enclosed by the heat exchanger housing 2 is bounded off by an exhaust gas inlet adapter 4a and an exhaust gas outlet adapter 4b, each of which are formed with an opening 5a, 5b, especially a through opening.

The heat exchanger housing 2 encloses an arrangement 6′ of a plurality of heat exchanger elements 7′, which is termed a core 6′ of the heat exchanger 1′. The platelike heat exchanger elements 7′ stacked one on top of another in a height direction H comprise a first wall element 7′a and a second wall element 7′b, which are joined to each other fluid-tight at the side surfaces oriented in the lengthwise direction L. The heat exchanger elements 7′ of the prior art, which are also shown in FIG. 1C in a single representation, are configured with a slight extension in the height direction H, a medium extension in a width direction B and a larger extension in the lengthwise direction L, the extension in the height direction H being significantly smaller than the extension in the width direction B and the extension in the width direction B is significantly smaller than the extension in the lengthwise direction L.

The heat exchanger elements 7′ each have a rib element 7′c punched out or shaped from sheet metal between the wall elements 7′a, 7′b. During the manufacture of the heat exchanger element 7′, the rib element 7′c is inserted into the volume enclosed by the wall elements 7′a, 7′b and soldered to the wall elements 7′a, 7′b.

During the operation of the heat exchanger 1′, the exhaust gas flows along the insides of the wall elements 7′a, 7′b which are oriented toward each other and around the ribs of the rib element 7′c and thus through an exhaust gas flow duct 11 through the heat exchanger element 7′, while the coolant flows along the outsides of the wall elements 7′a, 7′b.

The wall elements 7′a, 7′b are configured with bulges 8′, which are butted together in the assembled state of the heat exchanger 1′ or the core of the heat exchanger 1′ so that the wall elements 7′a, 7′b of adjacent heat exchanger elements 7′ with their outsides facing each other are arranged at a spacing from each other. Consequently, a gap is formed between the heat exchanger elements 7′, which serves as a flow path for the coolant. The heat exchanger elements 7′ stacked one above another and forming the core of the heat exchanger 1′ are enclosed by the heat exchanger housing elements 2a, 2b, while between the outer heat exchanger elements 7′ and the heat exchanger housing elements 2a, 2b there is formed a gap for the conducting of the coolant.

The coolant is introduced through an inlet opening 9a formed in a heat exchanger housing element 2a into the volume enclosed by the heat exchanger housing 2 and taken away through an outlet opening 9b formed in a heat exchanger housing element 2a. Each time the coolant flows through a connection port 10a, 10b.

FIG. 1D shows the heat exchanger 1′ of the prior art in a sectional representation. The exhaust gas is introduced through the opening 5a of the exhaust gas inlet adapter 4a into the heat exchanger 1′, is distributed in its flow through the exhaust gas inlet adapter 4a among the heat exchanger elements 7′, and flows through the exhaust gas flow ducts 11 in the lengthwise direction L through the heat exchanger 1′. Within the exhaust gas flow ducts 11 are arranged the rib elements 7′c, so that the exhaust gas flows along the ribs, which increase in particular the heat transfer surface.

Inside the exhaust gas outlet adapter 4b the mass flow of exhaust gas distributed among the exhaust gas flow ducts 11 is once again blended and taken away through the opening 5b of the exhaust gas outlet adapter 4b from the heat exchanger housing 2.

The coolant flows through the coolant flow ducts 12, which are formed each time between the adjacent heat exchanger elements 7′. The coolant flow ducts 12 are consequently bounded by the wall elements 7′a, 7′b and the heat exchanger housing elements 2a, 2b. The adjacent heat exchanger elements 7′ are joined together fluid-tight at the end faces oriented in the lengthwise direction L, that is, they are preferably soldered or welded together.

FIGS. 2A and 2B shows another embodiment of a heat exchanger element 7″ from the prior art. In contrast to the heat exchanger element 7′ with I-flow from FIG. 1A to 1D, the heat exchanger element 7″ has a U-flow at the exhaust gas side. The exhaust gas flows into the exhaust gas flow duct 11 at one end face of the wall elements 7″a, 7″b with an open configuration, flows in a first flow direction in the lengthwise direction L on one side of the heat exchanger element 7″ to the end formed distally to the end face, is deflected, and flows again in the lengthwise direction L opposite to the first flow direction after flowing in through the end face through the exhaust gas flow duct 11 to the end face, and then out from the exhaust gas flow duct 11 of the heat exchanger element 7″ at the end face. Between the wall elements 7″a, 7″b there is inserted a rib element 7″c which is preferably soldered to the wall elements 7″a, 7″b.

A bulge 8″ is oriented in the lengthwise direction L and is configured in combination with the rib element 7″c so as to divide the flow duct into two regions, in order to ensure the oppositely directed flow of the exhaust gas with deflection of the flow direction.

In the embodiments of the heat exchanger element 7′, according to FIG. 1A to 1D, and of the heat exchanger element 7″ according to FIGS. 2A and 2B of the prior art, the heat exchanger element 7′, 7″ comprises at least three different elements which are separated from each other: a first wall element 7′a, 7″a as the upper half of the exhaust gas flow duct 11, a punched-out rib element 7′c, 7″c as well as a second wall element 7′b, 7″b as the lower half of the exhaust gas flow duct 11. For the fabrication of the three elements, at least three different punching tools are required, which demands a high expenditure of material and causes high costs.

It is also known from the prior art how to shove a rib or several ribs into a tube with rectangular or oval cross section and solder them to the wall of the tube. The rib before being shoved into the tube is coated with solder, or alternatively a solder foil is also used. The tubes with rectangular cross section with rib, which are arranged inside the exhaust gas flow duct, are each shoved at the ends into a terminal perforated plate, which is arranged in the region of the exhaust gas inlet and in the region of the exhaust gas outlet. A plurality of tubes with rectangular cross section with rib and the terminal perforated plates form the core of the heat exchanger.

The tubes with rectangular or oval cross section are usually configured as endless laser-welded tubes, which must have a very high precision as well as a definite height dimension of the rib or the rib element in order to ensure a soldering of the individual elements. Alternatively, with the aid of an additional tool for the deforming of the tubes, especially for indenting the wall of the tubes with rectangular cross section, the distance between the pipe wall and the rib is minimized after the rib element has been shoved into the tube. High-precision elements and their fabrication methods, which are needed for a soldering of the tube to the rib element, cause a high expense and high costs. Furthermore, a guided conducting of the coolant through bulges 8″, as are especially evident in FIGS. 2A and 2B, is not possible, so that additional baffle plates must be installed for the guiding of the coolant.

The exhaust gas recirculation systems are specifically configured with corrugated ribs, since these have especially advantageous influence on the possible sooting especially in diesel-operated motor vehicles. Furthermore, the turbulence of the exhaust gas mass flow and thus the heat transfer from exhaust gas to the rib and to the coolant is also increased with corrugated ribs in the case of gasoline engines.

A secure and good soldering of the rib or the rib element to the respective wall element or the tube is essential, since in the first place the heat flow taken up by the rib or the rib element should be conducted to the coolant by the wall element or the tube wall and transferred to the coolant. If the rib or the rib element is not soldered to the wall element or the tube wall, a gap will form which is filled with exhaust gas, having an insulating effect and thus substantially impairing the heat transfer.

Furthermore, the exhaust gas and/or the coolant is under high pressure, so that a large pressure difference is established between the inside and the outside of the tube wall. The soldering of the rib or the rib element to the wall element or the tube wall thus prevents a distending and tearing of the tube wall.

In order to ensure a large-area connection of the rib or the rib element with the wall element or the tube wall, on the one hand a high precision with extremely slight tolerances of the dimensions of the ribs, especially the rib height, as well as the wall elements is absolutely essential. On the other hand, a great deal of solder is used in the fabrication of the known heat exchanger, which causes high costs for cost-intensive solder paste. Furthermore, the soldering process must ensure a good connection of the elements, and a poor connection reduces the stability and the risk of a crack will increase.

### SUMMARY OF THE INVENTION

The problem which the present invention proposes to solve is to provide a heat exchanger for exhaust gas cooling in motor vehicles which has a high cooling performance for slight pressure loss at the gas side. The heat exchanger should furthermore be space-saving due to a compact design. With a minimal number of individual elements, the robustness and thus the service life of the heat exchanger should be maximal. The costs incurred for the manufacture should be minimal.

The problem is solved by a heat exchanger for exhaust gas cooling, especially for motor vehicles, according to the invention. The heat exchanger comprises a heat exchanger housing with an exhaust gas inlet adapter and an exhaust gas outlet adapter, which encloses and bounds off a flow space for a coolant, and has an inlet opening as well as an outlet opening for the coolant. The heat exchanger is furthermore configured with platelike heat exchanger elements arranged in parallel with each other and forming exhaust gas flow ducts, through which exhaust gas flows and around which liquid coolant flows.

According to the concept of the invention, a heat exchanger element comprises two wall elements each with a top side and a bottom side. The wall elements are joined together fluid-tight on opposite side surfaces oriented in a lengthwise direction and are configured with ribs on the top side as well as the bottom side. The ribs are arranged on the one hand on an inner side and within the exhaust gas flow duct and on the other hand on an outer side of the heat exchanger element. Furthermore, adjacent heat exchanger elements arranged with outer sides facing each other are joined together fluid-tight at end faces abutting each other, forming a coolant flow duct. The ribs arranged on the outer side are arranged inside a coolant flow duct.

According to one modification of the invention, the wall elements are identical in configuration.

The ribs are preferably corrugated in the lengthwise direction.

The ribs advantageously have a substantially constant height. The height becomes less only toward an inlet region and an outlet region, each time forming a flow cross section. The inlet region and the outlet region are formed at opposite end faces of the heat exchanger elements and thus at the ends of the ribs extending in the lengthwise direction.

The flow cross section freed up by the decrease in height of the ribs extends in a transverse direction, that is, perpendicular to the lengthwise direction and thus perpendicular to the ribs.

According to a first alternative embodiment of the invention, the inlet region and/or the outlet region has a constant flow cross section.

According to a second alternative embodiment of the invention, the inlet region in one flow direction has a narrowing flow cross section and the outlet region in the flow direction has a widening flow cross section. The indicated flow direction preferably pertains to the flow direction of the coolant, which in both the inlet region and the outlet region advantageously flows into the heat exchanger and out from the heat exchanger, respectively, perpendicular to the lengthwise direction and thus perpendicular to the ribs.

According to another preferred embodiment of the invention, the ribs have different spacings from each other within the flow cross sections of the exhaust gas flow duct and the coolant flow duct. The flow cross sections of exhaust gas flow duct and coolant flow duct are consequently divided differently. This reduces the pressure losses of the exhaust gas mass flow and increases the thermal power transfer.

According to one modification of the invention, the wall element is formed from sheet metal with ribs molded therein.

The wall element has preferably a first side wall at the side surfaces extending in the lengthwise direction, which extends from a first end face to a second end face.

Furthermore, the wall element is advantageously configured with a second side wall at the end faces extending in a width direction, which extends from a first side surface to a second side surface.

The side walls are preferably arranged at an angle to the top side and the bottom side of the wall element, respectively.

According to one advantageous embodiment of the invention, the wall elements are formed from a metallic material. The wall elements are preferably soldered together.

The heat exchanger elements are advantageously arranged flush with each other at the end faces and at the side surfaces.

The heat exchanger according to the invention is likewise suited to cooling the charging air. In this case, the heat exchanger is arranged especially in the intake region of an internal combustion engine and serves to lower the temperature of the combustion air supplied to the engine. The heat is removed from the air and transferred for example to the coolant.

The heat exchanger is advantageously made of aluminum.

The problem is furthermore solved by a method according to the invention for the production of a heat exchanger element made from wall elements of a heat exchanger according to the invention. According to its concept, the method involves the following steps: punching out of at least two attached wall elements from a metal sheet; bending of one wall element at an angle of 90° around two bending lines arranged parallel to each other and extending in the lengthwise direction in a side surface arranged between the wall elements and placing of the one folded wall element on the other wall element; and closing of an exhaust gas flow duct by soldering or welding at one end along a connection line of the abutting side surfaces.

According to one modification of the invention, at least two heat exchanger elements are manufactured with the method from wall elements, wherein the method involves the following steps: punching out of at least four attached wall elements from a metal sheet, forming regions between the wall elements which are deformed during the method; bending of two wall elements situated next to each other at an angle of 90° around two bending lines arranged parallel to each other and extending in a transverse direction in an end face arranged between the wall elements and placing of the two folded wall elements on the other two wall elements; bending of two wall elements arranged one on top of the other at an angle of 90° around two bending lines arranged parallel to each other and extending in the lengthwise direction in a side surface arranged between the wall elements and placing of the two folded wall elements on the other two wall elements, and closing of two exhaust gas flow ducts and a coolant flow duct by soldering or welding along connection lines of the abutting side surfaces and end faces.

The plate heat exchanger with rib geometry according to the invention, especially one with a corrugated rib shape, has various further advantages in connection with the method according to the invention for the production of the wall elements: slight pressure loss at the gas side and high thermal power transfer; place-saving due to compact design; minimal number of individual elements, maximum durability and service life, requiring only one punching die for the formation of the heat exchanger or the heat exchanger element from identical wall elements; reduced complexity of the subassembly during the manufacturing and minimizing of failure mechanisms caused by inadequate soldering of connections; wall elements with rib contour have sufficiently high rigidity to withstand pressure acting on both sides, that is, internal pressures and external pressures, so that a soldering of the rib contours of adjoining wall elements is unnecessary, saving on a substantial amount of solder paste, and there is no failure of the heat exchanger due to inadequate soldering of the rib contours; slight requirements on the tolerances during the manufacturing, especially the rib geometry, in particular the rib height, of the wall elements, while only the widened starting regions and ending regions of the flow ducts need to have a high precision, since the two wall elements bordering a flow duct in the region of the ribs do not need to butt against each other; less material input for the same power transmission, and thus sparing of resources; less weight of the heat exchanger reduces the weight of the motor vehicle and the moving mass, which saves on fuel and lowers the emission of carbon dioxide; and minimal manufacturing costs, also due to elimination of large-area soldering operations.

### DESCRIPTION OF THE DRAWINGS

Further details, features and advantages of the invention will emerge from the following specification of sample embodiments making reference to the accompanying drawings.

FIGS. 1A to 2B: heat exchangers according to the prior art,

FIG. 3: a heat exchanger designed as a rib-type heat exchanger in an exploded representation,

FIG. 4A to 4D: putting together of heat exchanger elements from wall elements, forming an exhaust gas flow duct and a coolant flow duct, in perspective view,

FIG. 5A, 5B: four attached wall elements from FIG. 4D each with an inlet region and an outlet region for the coolant in side view and in top view,

FIG. 6A to 6C: wall elements with inlet regions and outlet regions formed for coolant in top view,

FIG. 7: heat exchanger in assembled form without enclosing heat exchanger housing elements in side view,

FIG. 8A, 8B: heat exchanger in assembled form without enclosing heat exchanger housing elements in perspective side view and in top view,

FIG. 9: wall element of a heat exchanger element for a U-flow exhaust gas flow duct in perspective view,

FIG. 10A to 10C: various rib geometries at exhaust gas side and coolant side, schematically and in sectional representation of the flow ducts,

FIG. 11A: heat exchanger element made from a first and second wall element fabricated from a single piece, and

FIG. 11B: several heat exchanger elements from FIG. 11A in a state assembled to form a core of the heat exchanger with an exhaust gas outlet adapter,

FIG. 12A to 12C: steps for the production of a heat exchanger element, similar to FIG. 11A, and it assembly to form a core of the heat exchanger,

FIG. 13A to 13C: the making of a heat exchanger element from wall elements fabricated from a single piece, and

FIG. 14A, 14B: comparative representation of the heat exchanger and a heat exchanger of the prior art, each in assembled form without enclosing heat exchanger housing elements in perspective side view.

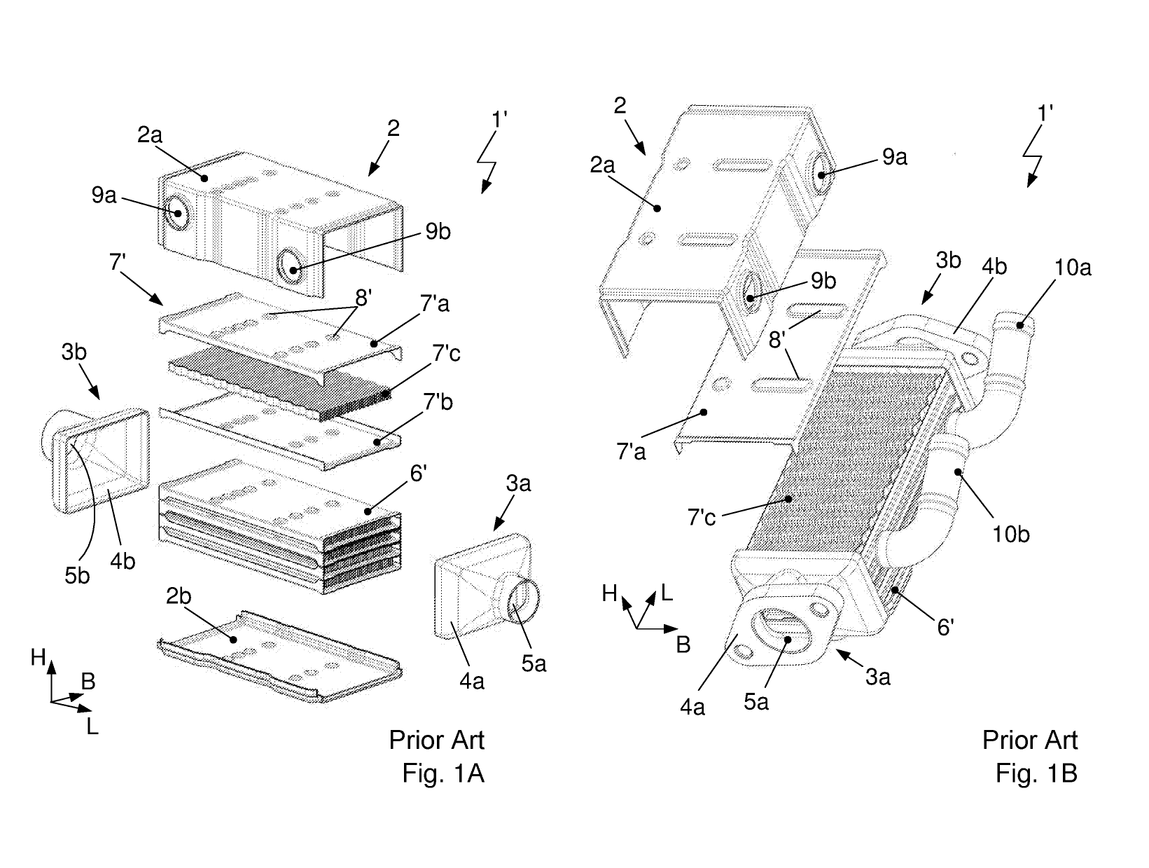

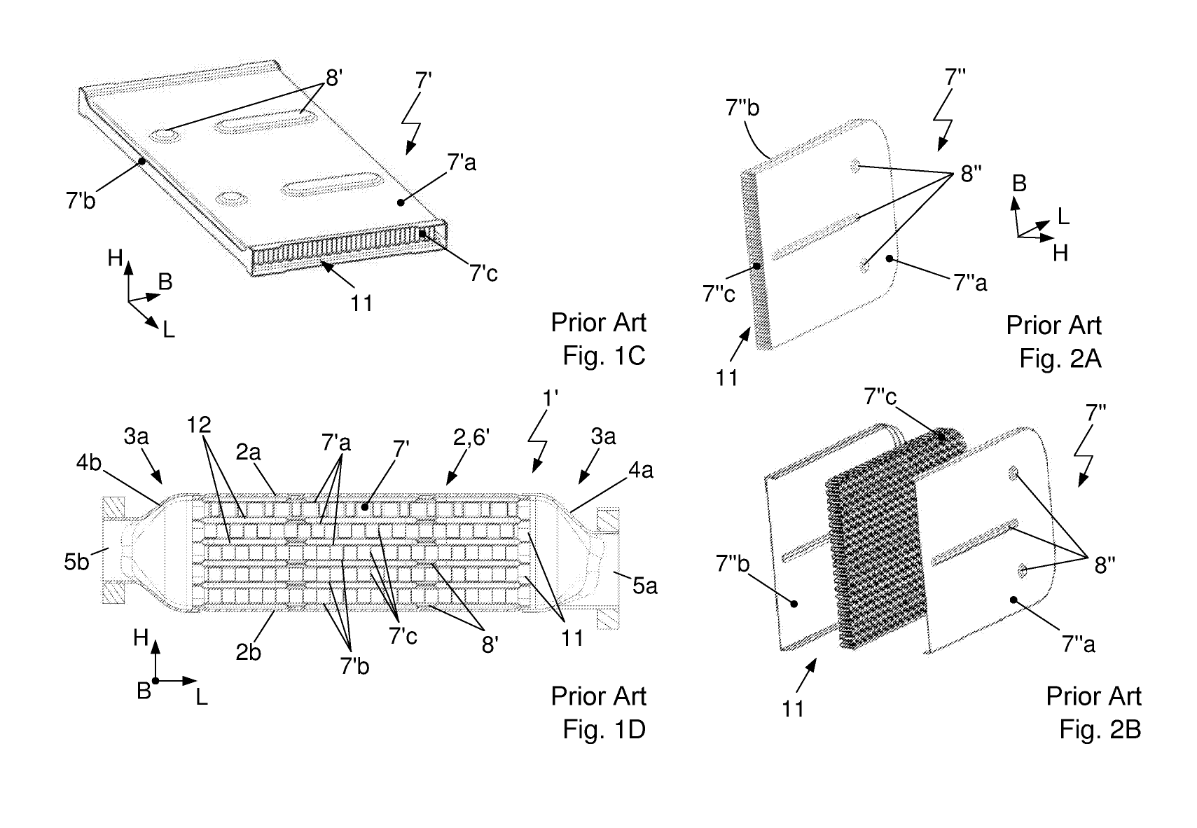

### DETAILED DESCRIPTION

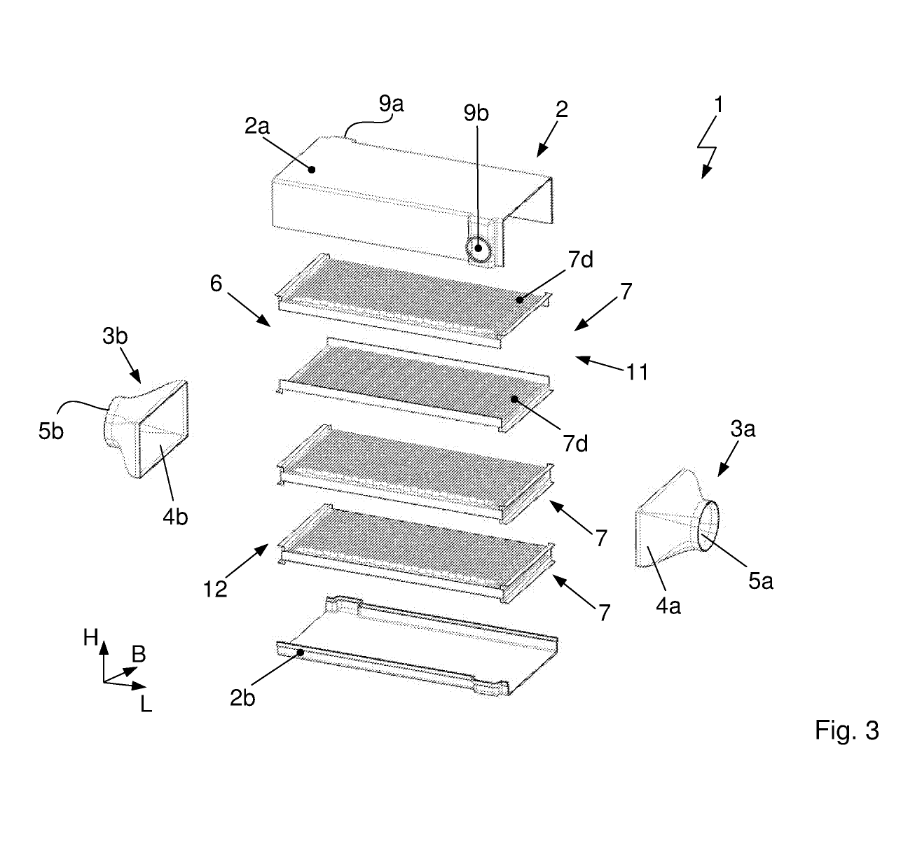

FIG. 3 shows a heat exchanger 1 designed as a ribbed heat exchanger in an exploded representation. The heat exchanger 1 through which exhaust gas and coolant flows is designed with a heat exchanger housing 2, comprising a first heat exchanger housing element 2a and a second heat exchanger housing element 2b, which in the enclosed state fully bounds off the volume enclosed by the heat exchanger housing 2. At the end faces of the heat exchanger housing 2 there are formed an exhaust gas inlet 3a and an exhaust gas outlet 3b. In the regions of the exhaust gas inlet 3a and exhaust gas outlet 3b formed distally to each other in a lengthwise direction L, the volume enclosed by the heat exchanger housing 2 is bounded off by an exhaust gas inlet adapter 4a and an exhaust gas outlet adapter 4b, each of which is formed with an opening 5a, 5b, especially a through opening.

The heat exchanger housing 2 encloses an arrangement of several heat exchanger elements 7, which form a core 6 of the heat exchanger. The platelike heat exchanger elements 7 stacked one on top of another in a height direction H are each formed from two wall elements 7d, which are joined fluid-tight to each other at the side surfaces oriented in the lengthwise direction L. The heat exchanger elements 7 are designed with a slight extension in the height direction H, a medium extension in the width direction B and a larger extension in the lengthwise direction L, the extension in the height direction H being much smaller than the extension in the width direction B and the extension in the width direction B much smaller than the extension in the lengthwise direction L. The wall elements 7d of the heat exchanger element 7 assembled to form the core 6 are arranged flush with each other at the end faces.

The wall elements 7d are preferably punched out from sheet metal and comprise ribs, especially corrugated ribs, on their surfaces, that is, on the top side and on the bottom side. The ribs are designed with a constant height. The corrugated shape of the ribs pertains to the extension in the lengthwise direction L and in the width direction B of the wall element 7d.

The wall elements 7d in the assembled state of the heat exchanger 1 or core 6 of the heat exchanger 1 are arranged with the ribs facing each other, so that the wall elements 7d of adjacent heat exchanger elements 7 oriented with their outer sides facing each other are also arranged with the lengthwise edges of the ribs facing each other. The outer sides of the heat exchanger elements 7 consequently form a gap, which serves as a coolant flow duct 12 and comprises ribs.

According to a first alternative embodiment, the two wall elements 7d bounding off a flow duct 11, 12 do not abut against each other in the region of the ribs. According to a second alternative embodiment, the ribs arranged within the coolant flow duct 12 abut against each other, while a gap is formed between the ribs arranged inside the exhaust gas flow duct 11.

The adjacent wall elements 7d can be soldered or welded together at the abutting regions of the ribs.

According to another alternative embodiment, two adjacent wall elements 7d are configured such that a gap is formed at the exhaust gas side and/or at the coolant side between the adjacent ribs. The ribs abut against each other at predetermined distances, so that no gap is formed locally, and the ribs are joined together, preferably by soldering. In this way, the arrangement can be stiffened according to the magnitude of the stresses with slight solder expenditure.

The heat exchanger elements 7 stacked one on top of the other in the height direction H, forming the core 6 of the heat exchanger 1, and are surrounded by the heat exchanger housing elements 2a, 2b. A coolant flow duct 12 is also formed each time between the outer heat exchanger elements 7 of the core 6 and the heat exchanger housing elements 2a, 2b. The adjacent heat exchanger elements 7 are in fluid-tight communication with each other at the preferably flush end faces, that is, they are preferably soldered or welded together.

During the operation of the heat exchanger 1, the exhaust gas flows along the inner sides of the wall elements 7d, facing each other, and also around the corrugated ribs of the wall elements 7d formed on the inner sides and thus through an exhaust gas flow duct through the heat exchanger element 7, while the coolant flows along the outer sides of the wall elements 7d and around the corrugated ribs of the wall elements 7d formed on the outer sides.

The exhaust gas is guided through the opening 5a of the exhaust gas inlet adapter 4a into the heat exchanger 1, in flowing through the exhaust gas inlet adapter 4a it is divided among the heat exchanger elements 7 and flows through the exhaust gas flow ducts 11 in the lengthwise direction L through the heat exchanger. The exhaust gas entering the exhaust gas flow duct flows along the ribs formed on the wall elements 7d, which increase in particular the heat transfer surface for the exhaust gas.

Inside the exhaust gas outlet adapter 4b, the exhaust gas mass flow divided among the exhaust gas flow ducts 11 is again mixed together and taken through the opening 5b of the exhaust gas outlet adapter 4b out from the heat exchanger housing 2.

The coolant is taken through the inlet opening 9a formed in the heat exchanger housing element 2a into the volume enclosed by the heat exchanger housing 2 and taken out through the outlet opening 9b formed in the heat exchanger housing element 2a. The coolant then flows through a connection port for the coolant, not shown, to a coolant circuit.

After flowing into the heat exchanger 1, the coolant is broken up into partial mass flows and taken through the coolant flow ducts 12 bounded between the adjacent heat exchanger elements 7 and by the heat exchanger housing elements 2a, 2b and then mixed together and taken out through the outlet opening 9b formed in the heat exchanger housing element 2a. The coolant then flows through a connection port for the coolant, not shown, to the coolant circuit.

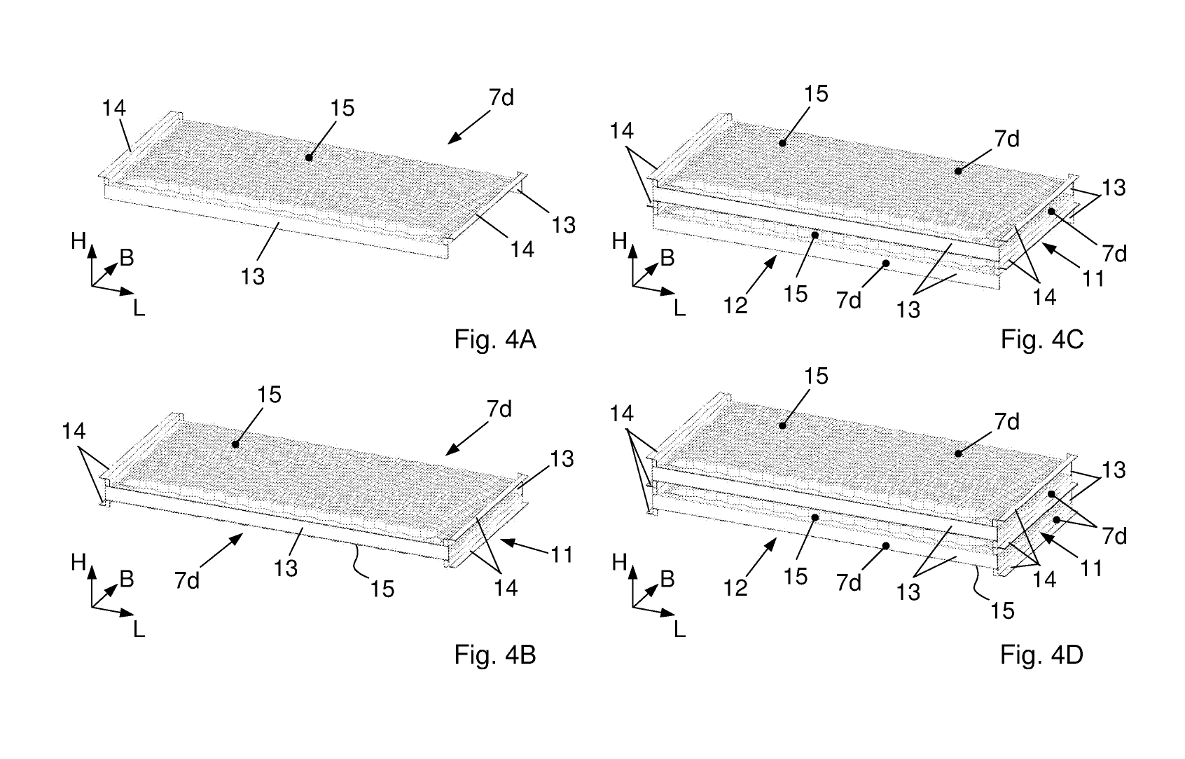

FIG. 4A to 4D show the putting together of heat exchanger elements 7 from wall elements 7d in perspective view. The wall elements 7d in the assembled state of the core 6 form at least one exhaust gas flow duct 11 and at least one coolant flow duct 12.

Each individual wall element 7d punched out from a metal sheet has ribs on the top side and the bottom side, forming a rib contour. The forming of the rib on the top side is concomitant with the forming of the rib on the bottom side. The ribs are corrugated in the lengthwise direction L of the wall element 7d. The ribs are furthermore arranged parallel to each other, so that the flow cross sections of the gap formed between the ribs are always constant and the flow cross sections of adjacent gaps are the same size.

The corrugations of the ribs run evenly to each other, and the ribs of adjacent wall elements 7d are parallel. According to an alternative embodiment, the ribs of adjacent wall elements 7d run in opposite direction or are staggered to each other, so that the ribs are not arranged opposite each other for the entire lengthwise extension, but only lie against each other in contact regions in which the ribs are arranged crossing each other.

At the long sides running in the lengthwise direction L the wall elements 7d each have a first side wall 13, which extends from the first end face to the second end face of the wall element 7d. The first side walls 13 are formed with a constant height, that is, a constant dimension in the height direction H, and point in a common height direction H.

At the narrow sides running in the width direction B the wall elements 7d each have a second side wall 14, which extends from the first long side to the second long side of the wall element 7d. The second side walls 14 are formed with a constant height, that is, a constant dimension in the height direction H, and point in a common height direction H. The first side walls 13 and the second side walls 14 are oriented in opposite directions.

The side walls 13, 14 are angled to the surface of the wall element 7d, preferably at an angle of 90°.

By putting together two wall elements 7d, according to FIG. 4B, such that the first side walls 13 of the wall elements 7d abut against each other, an exhaust gas flow duct 11 is fully bounded off. The respective opposite surfaces with the ribs 15 and the abutting first side walls 13 enclose the exhaust gas flow duct.

The first side walls 13 are soldered or welded together at the contact surfaces, so that a fluid-tight boundary is formed at the long sides of the wall elements 7d. The second side walls 14 are arranged in opposite direction to each other.

By further assembling of the two already interconnected wall elements 7d with a third wall element 7d, according to FIG. 4C, such that the second side walls 14 of the wall elements 7d lie against each other, a coolant flow duct 12 is fully bounded off. The respective opposite surfaces with the ribs 15 and the abutting second side walls 14 enclose the coolant flow duct 12. The second side walls 14 are soldered or welded together at the contact surfaces, so that a fluid-tight boundary is formed at the end faces of the wall elements 7d. The first side walls 13 are arranged in opposite direction to each other.

During the welding, the side walls 13, 14 being joined are advantageously butted against each other, while the side walls 13, 14 being joined during soldering are preferably arranged overlapping, so that the contact surfaces during soldering are larger than during welding.

Depending on the needs and the required size of the heat exchanger 1, a particular number of heat exchanger elements 7 each formed of two wall elements 7d will be joined together, while adjacent wall elements 7d are always oriented opposite each other in the height direction H. The wall elements 7d or heat exchanger elements 7 oriented flush with the second side walls 14 at the end faces form the core 6 of the heat exchanger 1, in which the exhaust gas flow ducts 11 and the coolant flow ducts 12 are arranged always in alternating manner.

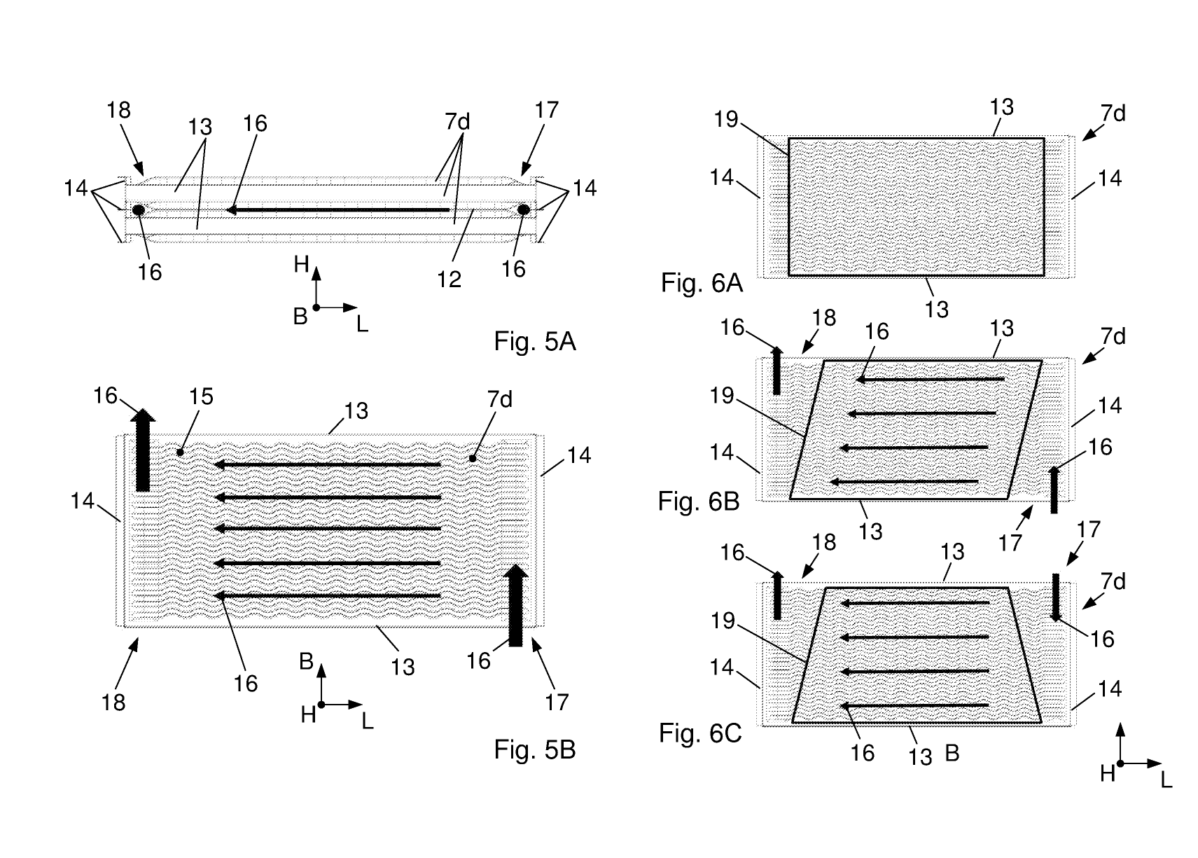

In FIGS. 5A and 5B the four assembled wall elements 7d from FIG. 4D are represented each with a designated inlet region 17 and a designated outlet region 18 for the coolant in side view and in top view.

The coolant here flows in the flow direction 16 through the inlet region 17 into the coolant flow duct 12. The coolant is guided along the end face of the wall elements 7d or along the second side walls 14 and distributed among the gaps formed between the ribs 15. The flow direction 16 of the coolant changes by 90° in the inlet region 17.

After flowing through the gaps formed between the ribs 15, the coolant is again blended in the outlet region 18, undergoes a 90° change in the flow direction 16, and is led out from the coolant flow duct 12.

The extension of the ribs 15 and thus the rib contour in the height direction H or the depth of penetration of the rib contour constantly diminishes for the coolant and also for the exhaust gas toward the inlet regions 17 and the outlet regions 18. This produces both in the inlet region 17 and in the outlet region 18 at the coolant side a free space for the distributing and blending of the coolant.

According to one alternative embodiment not shown, the rib contour only diminishes constantly in the height direction H or the depth of penetration of the rib contour toward the inlet regions 17 and the outlet regions 18 at the coolant side, and remains unchanged at the exhaust gas side.

The free spaces for the guiding of the coolant can be different in configuration thanks to the depth of penetration of the ribs 15, according to the position of the connection ports 10a, 10b of the coolant to the heat exchanger housing 2.

In the configuration of the heat exchanger elements 7d according to FIG. 5B, both the inlet region 17 and the outlet region 18 of the coolant have uniform and thus constant flow cross sections for the coolant. The connection ports 10a, 10b for the coolant are arranged on oppositely situated first side walls 13 of the heat exchanger elements 7d. The coolant flow ducts 12 receive a flow without reversal of direction from a first end face to a second end face and thus in an I-shape.

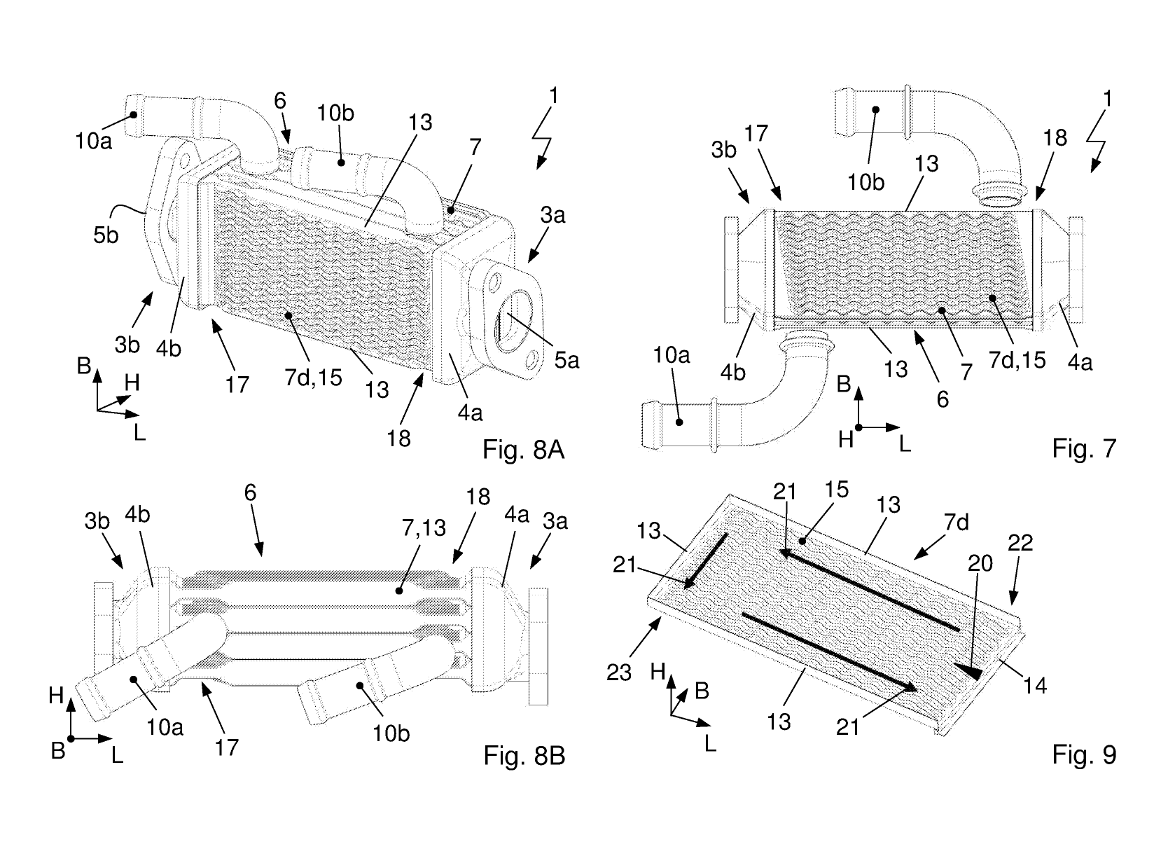

FIG. 6 shows wall elements 7d with configured inlet regions 17 and outlet regions 18 for the coolant in top view. FIG. 7 shows a heat exchanger 1 in assembled form without enclosing heat exchanger housing elements 2a, 2b in side view. FIGS. 8A and 8B show a heat exchanger 1 in assembled form without enclosing heat exchanger housing elements 2a, 2b in perspective side view and in top view.

The first view of FIG. 6A shows the configuration of the inlet region 17 and the outlet region 18 according to FIG. 5B. The flow region 19 of the coolant has a rectangular shape. The connection ports 10a, 10b for the coolant can be arranged both at oppositely situated first side walls 13 of the heat exchanger elements 7d, according to FIG. 5B, or on a common first side wall 13. The flow cross sections of inlet region 17 and outlet region 18 along the second side walls 14 are constant.

In the second embodiment, according to the second view of FIG. 6B as well as according to FIG. 7, the flow region 19 of the coolant has the shape of a parallelogram. The connection ports 10a, 10b for the coolant are arranged on oppositely situated first side walls 13 of the heat exchanger elements 7d or on oppositely situated long sides of the heat exchanger 1, similar to FIG. 5B.

In the third embodiment, according to the third view of FIG. 6C as well as FIGS. 8A and 8b, the flow region 19 of the coolant has the shape of a trapezium. The connection ports 10a, 10b for the coolant are arranged on a common first side wall 13 of the heat exchanger elements 7d or on a common long side of the heat exchanger 1. The extension of the first side walls 13 in the height direction H is adapted to the ribs 15 or to the rib contour. The shapes of the first side walls 13 here correspond to the respective adjacent ribs 15.

In both the second and the third embodiment, the flow cross section for the coolant becomes smaller in the inlet region 17 in the flow direction 16 of the coolant, while the flow cross section for the coolant becomes greater in the outlet region 18 in the flow direction 16 of the coolant and thus in the direction along the second side walls 14.

FIG. 9 shows a wall element 7d of a heat exchanger element 7 for a U-shaped exhaust gas flow duct 11 in perspective view.

The exhaust gas is guided by an exhaust gas baffle element 20 arranged in an inlet/outlet region 22 of the exhaust gas in the flow direction 21 through a first part of the flow duct 11. The first part of the flow duct 11 is separated by a first side wall 13 and a rib 15 situated centrally in regard to the width B in the lengthwise direction L from a second part of the flow duct 11. The ribs 15 of two adjacent wall elements 7d at the exhaust gas side, forming a partition wall between the first and the second part of the flow duct 11, run only parallel and lie gas-tight against each other, so that no gap is formed. An opposite running arrangement of these ribs 15 is ruled out. These ribs 15 arranged centrally in relation to the width B in the lengthwise direction L are advisedly soldered together.

After the exhaust gas flows out from the first part of the flow duct into a deflection region 23 formed at an end face of the wall elements 7d, the flow direction of the exhaust gas is deflected by 180° and the exhaust gas is taken back through the second part of the flow duct 11 to the inlet/outlet region 22 of the exhaust gas. The ribs 15 in the deflection region 23 at the exhaust gas side are configured such that the height becomes smaller toward the end of the wall element 7d, forming a deflection flow cross section. The height of the ribs 15 can decrease down to 0 mm. The exhaust gas inlet 3a and exhaust gas outlet 3b of the heat exchanger housing 2, not shown, are arranged at one end face of the 20 heat exchanger 1.

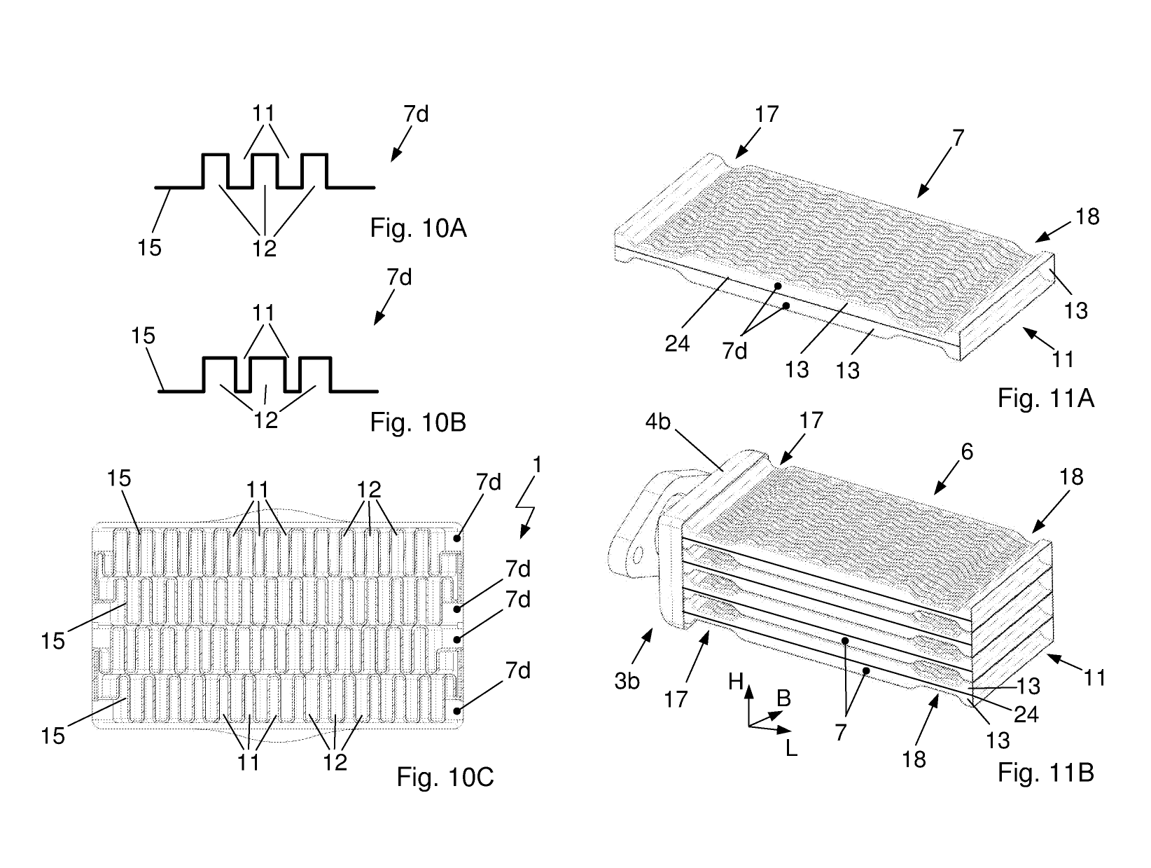

FIGS. 10A to 10C show different rib geometries at the exhaust gas side and the coolant side, schematically per FIGS. 10A and 10B, and in sectional representation of the exhaust gas flow duct 11 and the coolant flow duct 12 per FIG. 10C.

In the view of FIG. 10A, the rib 15 divides the flow ducts 11 into equal flow cross sections. The rib 15 is configured such that equal distances are present for the flow ducts 11, 12. With an unequal partitioning of the distances for the flow ducts 11, 12, according to the view of FIG. 10B as well as FIG. 10C, the flow cross sections at the exhaust gas side, i.e., the flow cross sections of the exhaust gas flow duct 11, become larger. At the same time, the flow cross sections at the coolant side, i.e., the flow cross sections of the coolant flow duct 12, become smaller. The adaptation of the ribs 15 accomplishes an improved transfer of the thermal power. Furthermore, the increasing of the flow cross sections of the exhaust gas flow duct 11 leads to a decreasing of the pressure losses on the exhaust gas side.

FIG. 11A shows a heat exchanger element 7 formed from a first and second wall element 7d made from a single piece. FIG. 11B shows several heat exchanger elements 7 from FIG. 11A in a state assembled with an exhaust gas outlet adapter 4b of an exhaust gas outlet 3b of the housing 2 to form a core 6 of the heat exchanger 1.

The first wall element 7d, also called the lower ribbed plate, and the second wall element 7d, also called the upper ribbed plate, are fabricated in a punched-out component. By bending the second wall element 7d at an angle of 90° each time about two bending lines, not shown, running parallel to each other through the rear first side wall 13 in the lengthwise direction L, the second wall element 7d is placed on top of the first wall element 7d and the exhaust gas flow duct 11 is enclosed. By means of a soldering or welding at one end along a connection line 24 of the side edges of the adjoining first side walls 13, the exhaust gas flow duct 11 is closed gas-tight in the lengthwise direction L.

The heat exchanger 1 is assembled by a stacking of the so fabricated heat exchanger elements 7 in the height direction H and a following connecting of the stacked heat exchanger elements 7 to the elements of the heat exchanger housing 2, such as the depicted exhaust gas outlet adapter 4b.

When fabricating the heat exchanger elements 7 from the wall elements 7d with the first side walls 13, the second side walls 14 and especially the ribs 15 or the rib geometry, few requirements are placed on the tolerances, especially for the rib geometry and in particular the extension of the ribs 15 in the height direction H, since the two wall elements 7d bounding off a flow duct 11, 12 do not have to abut against each other in the region of the ribs 15. Only the widened starting regions and end regions of the flow ducts 11, 12, that is, the deflection/inlet regions 17 and the deflection/outlet regions 18, need to be fabricated with high precision.

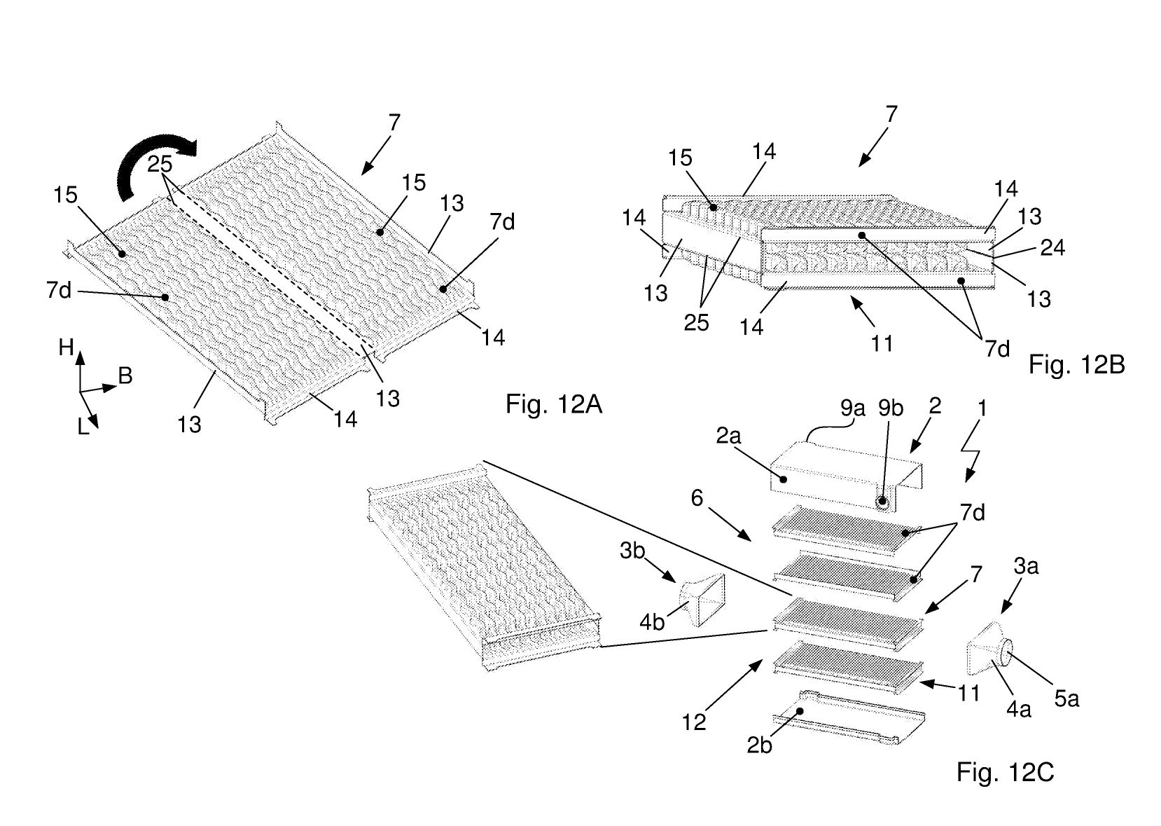

FIGS. 12A to 12C show the steps in making a heat exchanger element 7, similar to FIG. 11A, and the putting together of the heat exchanger elements 7 to form a core 6 of the heat exchanger 1.

After being punched out, the two wall elements 7d, also called the lower and upper ribbed plate, are arranged next to each other, as is also seen from FIG. 12A. The outer, first side walls 13 extending in the lengthwise direction L stick out vertically upward from the surface on the long sides of the punched part. The second side walls 14 extending at the end faces stick out vertically downward from the surface at the transverse sides, differing from the long sides of the punched part. The heat exchanger element 7 formed from two wall elements 7d consequently has four second side walls 14 and two first side walls 13, which are arranged at the outer edge of the punched part. Between the wall elements 7d there is formed a region without ribs 15 or without rib contour, which will be later on formed into two additional first side walls 13.

As a result of the bending of the second wall element 7d at an angle of 90° about two bending lines 25 running parallel to each other through the region without ribs 15 formed between the wall elements 7d, which is indicated by means of the arrow in FIG. 12A, the second wall element 7d is placed on top of the first wall element 7d and the exhaust gas flow duct 11 is enclosed, per FIG. 12B.

By means of a soldering or welding at one end along a connection line 24 of the side edges of the now juxtaposed and outer first side walls 13 prior to the bending process, the exhaust gas flow duct 11 is closed gas-tight in the lengthwise direction L.

The so fabricated heat exchanger elements 7 are stacked one on top of another in the height direction H of the heat exchanger 1 according to FIG. 12C and then soldered to the elements of the heat exchanger housing 2, such as the exhaust gas inlet adapter 4a, the exhaust gas outlet adapter 4b and the heat exchanger housing elements 2a, 2b.

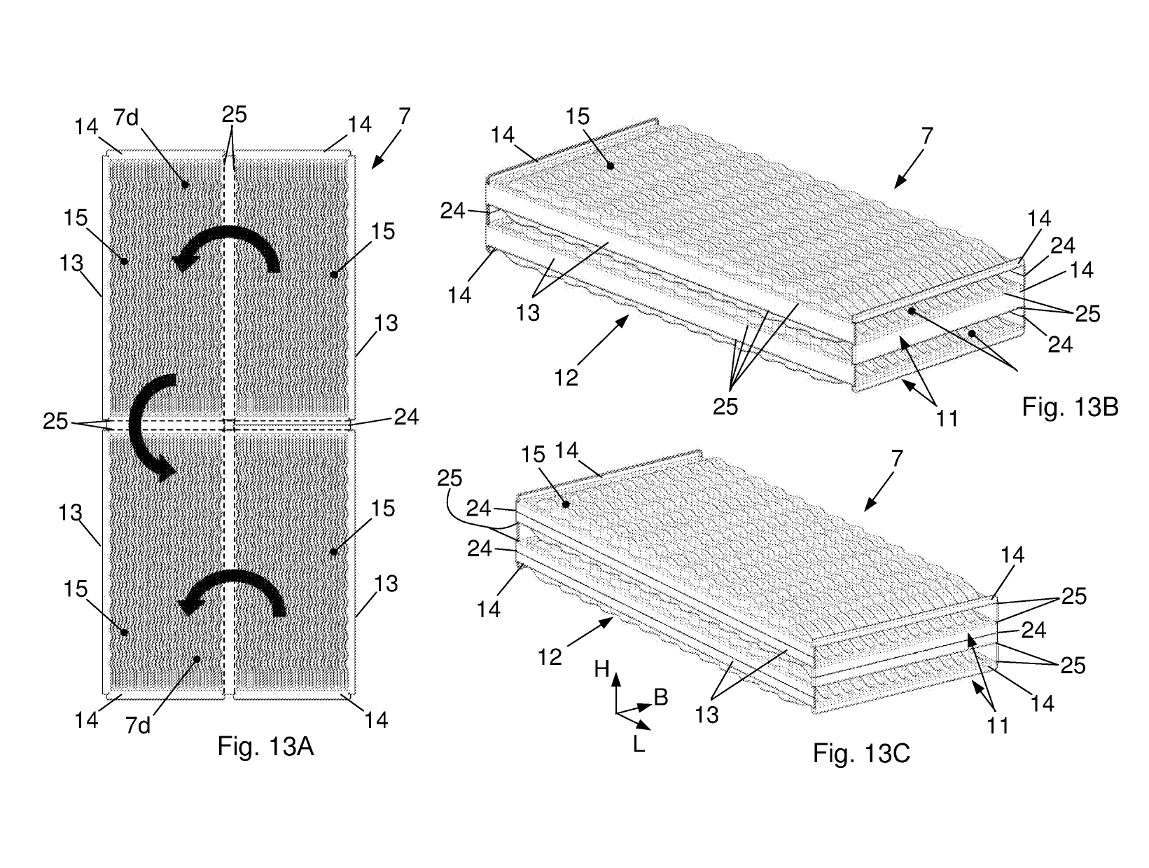

FIG. 13 shows the steps in making two heat exchanger elements from four wall elements 7d fabricated from a single piece.

By a further nesting of the wall elements 7d on a punched part, the punching complexity and the bending complexity can be further increased. This may eliminate other fabrication steps, such as the exact stacking of prefabricated heat exchanger elements 7 and steps of soldering or welding. Besides the drastic reduction in the number of soldered connections and welded connections, which always constitute a greater risk of failure, the number of individual elements of the heat exchanger 1 is also further reduced. For the case of two flow ducts 11, 12, for example, starting with a fabrication according to FIG. 4 with six connections, or a fabrication according to FIGS. 12A-12C with four connections, now only three connections will be soldered or welded.

After being punched out, the four wall elements 7d are arranged alongside each other in a common plane, as is seen in FIG. 13A. The other four first side walls 13 extend in the lengthwise direction L and stick out perpendicularly from the surface on the long sides of the punched part.

The four side walls 14 extending at the end faces stick out from the surface at the transverse sides, differing from the long sides of the punched part. The heat exchanger element 7 formed from four wall elements 7d consequently has four second side walls 14 and four first side walls 13, which are arranged at the outer edge of the punched part. Between the wall elements 7d there are formed four regions without ribs 15 or without rib contour, which will later on be shaped into four additional first side walls 13 as well as four additional second side walls 14.

As a result of the bending of the wall element 7d situated on the right side at an angle of 90° about two bending lines 25 running parallel to each other through the region without ribs 15 formed between the right-side and the left-side wall elements 7d, which is indicated by means of the arrows in FIG. 13A, the two wall elements 7d arranged at the right side are placed on top of the two wall element 7d arranged at the left side. After this, the wall elements 7d arranged at the top in FIG. 13A and placed against each other or the now formed first heat exchanger element 7 is bent at an angle of 90° about two bending lines 25 running parallel to each other through the region without ribs 15 formed between the wall elements 7d in the transverse direction and likewise placed one on top of the other. The punched metal sheet is interrupted at the connection line 24.

By means of a soldering or welding along the two connection lines 24 of the side edges of the now juxtaposed and outer four first side walls 13 prior to the bending process, the two exhaust gas flow ducts 11 are closed gas-tight in the lengthwise direction L, which is shown in FIGS. 13B and 13C. Likewise, the coolant flow duct 12 is closed fluid-tight by soldering or welding along the connection line 24 of the side edges of the now juxtaposed and out two second side walls 14 prior to the bending process in the width direction B.

The number of wall elements made from a single piece and their nesting on a punched part can be increased at will, in order to further reduce the number of connection seams to be soldered or welded.

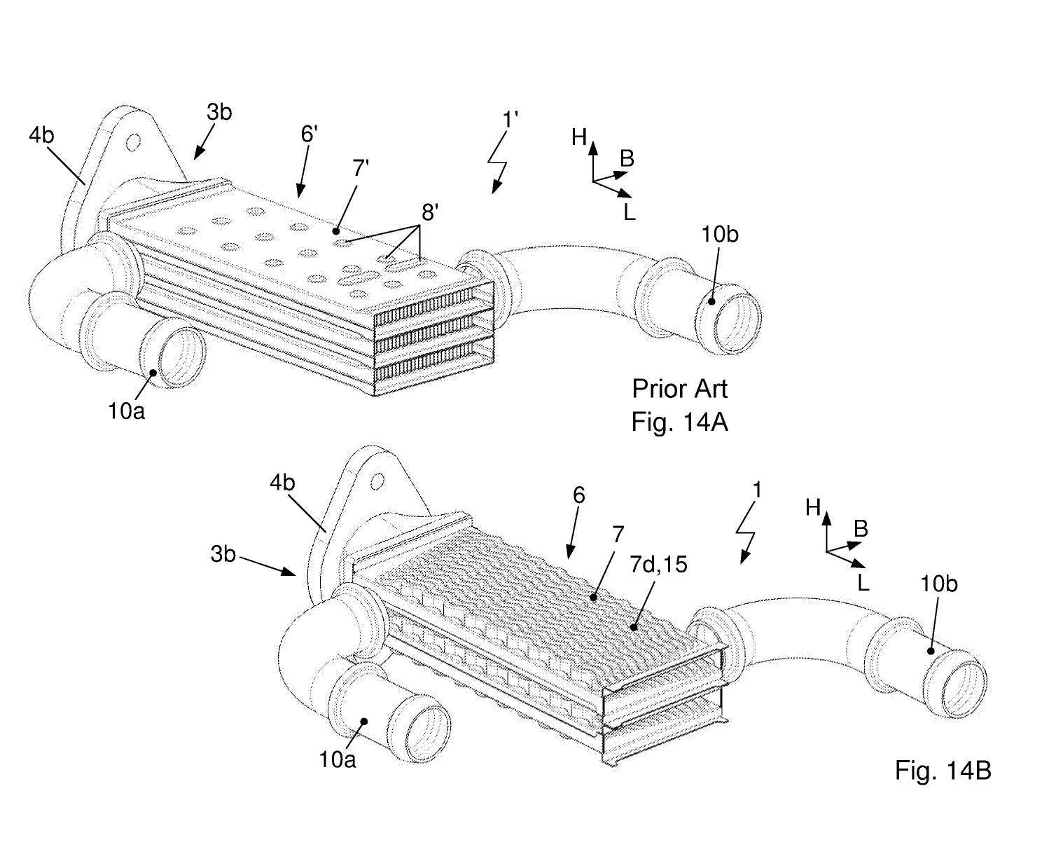

FIGS. 14A and 14B show a comparative representation of the heat exchanger 1 and a heat exchanger 1′ of the prior art, each time in assembled form without enclosing heat exchanger housing elements in perspective side view.

It becomes clear that the heat exchangers 1, 1′ differ essentially in the heat exchanger elements 7 formed from the wall elements, while the heat exchanger housings with the exhaust gas inlets and exhaust gas outlets and the corresponding exhaust gas inlet adapters and exhaust gas outlet adapters 4b as well as the connection ports 10a, 10b for the coolant do not differ.

### LIST OF REFERENCE NUMBERS

1, 1′ Heat exchanger
2 Heat exchanger housing
2a First heat exchanger housing element
2b Second heat exchanger housing element
3a Exhaust gas inlet of heat exchanger housing 2
3b Exhaust gas outlet of heat exchanger housing 2
4a Exhaust gas inlet adapter of heat exchanger housing 2
4b Exhaust gas outlet adapter of heat exchanger housing 2
5a Opening of exhaust gas inlet adapter
5b Opening of exhaust gas outlet adapter
6, 6′ Arrangement of heat exchanger elements, core
7, 7′, 7″ Heat exchanger element
7′a, 7″a First wall element
7b, 7′b, 7″b Second wall element
7′c, 7″c Rib element of heat exchanger element 7′, 7″
7d Wall element
8, 8′, 8″ Bulge of wall element
9a Coolant inlet opening
9b Coolant outlet opening
10a, 10b Coolant connection port
11 Exhaust gas flow duct, flow duct
12 Coolant flow duct, flow duct
13 Wall element of first side wall 7d
14 Wall element of second side 7d
15 Ribs wall element 7d
16 Coolant flow direction
17 Coolant deflection/inlet region—coolant transverse flow
18 Coolant deflection/outlet region—coolant transverse flow
19 Coolant flow region
20 Exhaust gas baffle element
21 Exhaust gas flow direction
22 Exhaust gas inlet/outlet region
23 Exhaust gas deflection region
24 Connection line
25 Bending line
L Lengthwise direction, length
B Width
H Height

1. A heat exchanger for exhaust gas cooling, especially for motor vehicles, the heat exchanger comprising:
a heat exchanger housing with an exhaust gas inlet adapter and an exhaust gas outlet adapter, the heat exchanger encloses and bounds a flow space for a coolant, and includes a coolant inlet opening and a coolant outlet opening; and
a plurality of platelike heat exchanger elements arranged in parallel with each other and forming exhaust gas flow ducts, through which exhaust gas flows and around which liquid coolant flows, wherein each of the heat exchanger elements comprises two wall elements, each of the wall elements having a top side and a bottom side, wherein the wall elements are joined together fluid-tight on opposite side surfaces oriented in a lengthwise direction and are configured with ribs on the top side and the bottom side, the ribs arranged on an inner side within the exhaust gas flow ducts, and outer sides of each of the heat exchanger elements, and wherein adjacent heat exchanger elements arranged with the outer sides facing each other are joined together fluid-tight at end faces abutting each other, forming a coolant flow duct, wherein the ribs arranged on the outer sides of the heat exchanger elements are arranged inside the coolant flow duct.

2. The heat exchanger according to claim 1, wherein the wall elements are identical in configuration.

3. The heat exchanger according to claim 1, wherein the ribs are corrugated in the lengthwise direction.

4. The heat exchanger according to claim 1, wherein the ribs have a substantially constant height, wherein the height decreases toward an inlet region and an outlet region, each time forming a flow cross section, wherein the inlet region and the outlet region are formed adjacent opposite end faces of the heat exchanger elements.

5. The heat exchanger according to claim 4, wherein at least one of the inlet region and the outlet region has a constant flow cross section.

6. The heat exchanger according to claim 4, wherein the inlet region in a first flow direction has a narrowing flow cross section and the outlet region in the first flow direction has a widening flow cross section.

7. The heat exchanger according to claim 1, wherein the ribs have different spacings from each other within the flow cross sections of the exhaust gas flow duct and the coolant flow duct.

8. The heat exchanger according to claim 1, wherein the wall element is formed from sheet metal with ribs molded therein.

9. The heat exchanger according to claim 1, wherein the heat exchanger elements are arranged flush with each other at the end faces.

10. The heat exchanger according to claim 1, wherein the heat exchanger elements are arranged flush with each other at the side surfaces.

11. The heat exchanger according to claim 1, wherein the wall element is configured with a first side wall at the side surfaces extending in the lengthwise direction, which extends from a first one of the end faces to a second one of the end faces.

12. The heat exchanger according to claim 1, wherein the wall element comprises a second side wall at each of the end faces extending in a width direction, the second sidewall extending from a first one of the side surfaces to a second one of the side surfaces.

13. The heat exchanger according to claim 1, wherein the wall elements are formed from a metallic material.

14. A method for production of a heat exchanger element made from wall elements of a heat exchanger, the method comprising the steps of:
punching out at least two attached wall elements from a metal sheet;
bending a first wall element relative to a second wall element, the first wall element bent at an angle of 90° about each of two bending lines arranged parallel to each other and extending along a lengthwise direction in a side surface arranged between the first wall element and the second wall element;
placing the first wall element on the second wall element; and
closing an exhaust gas flow duct by soldering or welding at one end along a connection line of the side surfaces.

15. A method for production of at least two heat exchanger elements manufactured from wall elements, the method comprising the steps of:
punching out at least four attached wall elements from a metal sheet, forming regions between the wall elements which are deformed during the method;
bending a first pair of adjacent wall elements with respect to a second pair of adjacent wall elements, the first pair of the wall elements bent at an angle of 90° about each of two bending lines arranged parallel to each other and extending in the lengthwise direction in a side surface arranged between the first pair of the wall elements and the second pair of the wall elements;
placing the first pair of the wall elements on the second pair of the wall elements to form a first heat exchanger element and a second heat exchanger element;
bending the first heat exchanger element at an angle of 90° about each of two bending lines arranged parallel to each other and extending in a transverse direction in an end face arranged between the first heat exchanger element and the second heat exchanger element;
placing the first heat exchanger element on the second heat exchanger element; and
closing two exhaust gas flow ducts and a coolant flow duct by soldering or welding along connection lines of the abutting side surfaces and end faces.
